(19) United States
(12) Patent Application Publication
(10) Pub. No.: US 2026/0204700 A1
(43) Pub. Date: Jul. 16, 2026

(54) SECONDARY BATTERY AND SECONDARY BATTERY PACK CONTAINING SECONDARY BATTERY

(71) Applicant: SAMSUNG SDI CO., LTD., Yongin-si (KR)

(72) Inventor: UiJeong RO, Yongin-si (KR)

(21) Appl. No.: 19/302,284

(22) Filed: Aug. 18, 2025

(30) Foreign Application Priority Data
Jan. 13, 2025 (KR) 10-2025-0004534

(51) Int. Cl. H01M 50/15; H01M 10/42; H01M 50/105; H01M 50/171; H01M 50/247; H01M 50/249

(52) U.S. Cl. CPC H01M 50/15; H01M 10/425; H01M 50/105; H01M 50/171; H01M 50/247; H01M 50/249

(57) ABSTRACT

The present disclosure relates to a secondary battery and a secondary battery pack containing the same, and the technical problem to be solved is to provide a secondary battery and a secondary battery pack containing the same, in which, by adding a reinforcing member made of a heat-shrinkable material to between a cover member covering the outside of a battery cell and the battery cell, the adhesion and rigidity of the central part of the battery cell can be reinforced. To this end, provided is a secondary battery comprising: a battery cell comprising an electrode assembly and a case accommodating the electrode assembly; a cover member covering at least a portion of a first cell side of the battery cell and a second cell side opposite to the first cell side; and a reinforcing member attached to the second cell side and overlapping the cover member on at least a portion of the second cell side.

### CROSS-REFERENCE TO RELATED APPLICATION

The present application claims priority to and the benefit of Korean Patent Application No. 10-2025-0004534, filed on Jan. 13, 2025, in the Korean Intellectual Property Office, the entire disclosure of which is incorporated herein by reference.

### BACKGROUND

### 1. Field

Embodiments of the present disclosure relate to a secondary battery and a secondary battery pack containing the secondary battery.

### 2. Description of the Related Art

Unlike a primary battery, a secondary battery may be charged and discharged. Low-capacity secondary batteries having a single battery cell packaged in the form of a pack are widely employed in small, portable electronic devices, such as smart phones, feature phones, laptop computers, digital cameras, camcorders, and the like, while large-capacity secondary batteries are widely used as power sources for driving motors in hybrid vehicles, electric vehicles, and the like, as well as batteries for power storage. The secondary battery includes an electrode assembly consisting of a positive electrode and a negative electrode, a case that accommodates the electrode assembly, and electrode terminals connected to the electrode assembly.

General consumers may disassembly a secondary battery used in a small electronic device. Accordingly, there is a need to configure the secondary battery such that it can be readily disassembled from the frame of the small electronic device.

The above information disclosed in this Background section is only for enhancement of understanding of the background of the invention and therefore it may contain information that does not constitute prior art.

### SUMMARY

The present disclosure relates to a secondary battery and a secondary battery pack containing the secondary battery, in which, by adding a reinforcing member including a heat-shrinkable material between a cover member covering the outside of a battery cell and the battery cell. Accordingly, adhesion and rigidity of the central part of the battery cell can be reinforced.

However, the technical problems to be achieved in the embodiment of the disclosure are not limited to the technical problems mentioned above, and other technical problems not mentioned herein will be clearly understood from the following description by those skilled in the art to which the disclosure belongs.

A secondary battery according to an embodiment of the present disclosure may include: a battery cell comprising an electrode assembly and a case accommodating the electrode assembly; a cover member covering at least a portion of a first cell side of the battery cell and a second cell side opposite to the first cell side; and a reinforcing member attached to the second cell side of the battery cell and overlapping the cover member on at least a portion of the second cell side of the battery cell.

Embodiments of the present disclosure provide a secondary battery including: a battery cell including an electrode assembly and a case accommodating the electrode assembly; a cover member covering at least a portion of a first cell side of the battery cell and at least a portion of a second cell side of the battery cell, the second cell side opposite to the first cell side; and a reinforcing member attached to the second cell side and overlapping the cover member on at least a portion of the second cell side.

In some embodiments, the cover member may include: a main portion having an area corresponding to a first cell side of the battery cell; and a wing portion covering a lateral cell side extending from the main portion and connecting the first cell side of the battery cell and the second cell side of the battery cell and at least a portion of a second cell side of the battery cell.

In some embodiments, the cover member includes: a main portion having an area corresponding to the first cell side; and a wing portion extending from the main portion and covering a lateral cell side and at least a portion of the second cell side.

In some embodiments, the wing portion may include a connection region extending from an end of the main portion and bent to cover a lateral cell side of the battery cell; and an edge region extending from the connection region and bent to cover at least a portion of a second cell side of the battery cell.

In some embodiments, the wing portion includes: a connection region extending from an end of the main portion and bent to cover the lateral cell side; and an edge region extending from the connection region and bent to cover at least a portion of the second cell side.

In some embodiments, the cover member may include a first cover side exposed to the outside and a second cover side facing the battery cell, the cover member further including a first adhesive layer attached to the first cover side of the main portion.

In some embodiments, the cover member further comprises a first cover side exposed to an exterior, a second cover side facing the battery cell, and a first adhesive layer attached to a region of the first cover side corresponding to the main portion.

In some embodiments, the cover member may include a non-bonded region positioned on a second cover side of the main portion.

In some embodiments, the cover member further comprises a non-bonded region positioned on a region of the second cover side corresponding to the main portion.

In some embodiments, the cover member may include a non-bonded region positioned on a second cover side of the connection region.

In some embodiments, the cover member further comprises a non-bonded region positioned on a region of the second cover side corresponding to the connection region.

In some embodiments, the cover member may further include a second adhesive layer attached to a second cover side of the edge region.

In some embodiments, the cover member further comprises a second adhesive layer attached to a region of the second cover side corresponding to the edge region.

In some embodiments, the reinforcing member may be interposed between the edge region of the cover member and the second cell side of the battery cell.

In some embodiments, the reinforcing member is interposed between the edge region and the second cell side.

In some embodiments, the reinforcing member may include a first reinforcing side facing the second cell side of the battery cell; and a second reinforcing side facing the second cover side of the edge region of the cover member.

In some embodiments, the reinforcing member includes: a first reinforcing side facing the second cell side; and a second reinforcing side facing the second cover side corresponding to the edge region.

In some embodiments, the reinforcing member may include a reinforcing member adhesion layer attached to the first reinforcing side thereof.

In some embodiments, the reinforcing member further includes a reinforcing member adhesion layer attached to the first reinforcing side.

In some embodiments, a first reinforcing side of the reinforcing member may be attached to a second cell side of the battery cell, and at least a portion of the second reinforcing side of the reinforcing member may be attached to a second cover side of the edge region by the second adhesive layer of the cover member.

In some embodiments, the first reinforcing side is attached to the second cell side, and at least a portion of the second reinforcing side is attached to the second cover side corresponding to the edge region by the second adhesive layer.

In some embodiments, the reinforcing member may be made of a heat-shrinkable material.

In some embodiments, the reinforcing member includes a heat-shrinkable material.

In some embodiments, the reinforcing member may include at least two cut-out portions provided in the edge region, and the at least two cut-out portions may form a pair.

In some embodiments, the reinforcing member includes at least two cut-out portions at the edge region.

In some embodiments, the cut-out portions of the reinforcing member may be provided at the respective corner positions of the battery cell, and the number of the cut-out portions may correspond to the number of the wing portions.

In some embodiments, the at least two cut-out portions are located at corner positions of the battery cell, and wherein a number of the at least two cut-out portions is equal to a number of the wing portions.

In some embodiments, the cut-out portions may be cut toward the center of the reinforcing member, and the length of the cut portion of each of the cut-out portions may be 20% to 40% of the maximum length extending from one side to the other side of the reinforcing member.

In some embodiments, the at least two cut-out portions are cut toward a center of the reinforcing member, and a length of each of the cut-out portions are about 20% to about 40% of a maximum length extending from one side to an opposite side of the reinforcing member.

In some embodiments, the planar area of the reinforcing member may be 80% to 90% of the area of the second cell side of the battery cell.

In some embodiments, a planar area of the reinforcing member is about 80% to about 90% of the area of the second cell side.

In some embodiments, the edge region of the cover member may entirely cover the second cell side of the battery cell, and the second cover side of the edge region may be attached to at least a portion of the reinforcing member.

In some embodiments, the edge region of entirely covers the second cell side, and wherein the second cover side corresponding to the edge region is attached to at least a portion of the reinforcing member.

In some embodiments, the reinforcing member may include a central region and a plurality of extension regions extending from the central region.

In some embodiments, at the end of the edge region of the cover member, tension may be applied to the central part of the battery cell.

In some embodiments, at the end of the edge region, tension is applied to a central part of the battery cell.

A secondary battery pack according to an embodiment of the present disclosure may include: a battery cell comprising an electrode assembly and a case accommodating the electrode assembly; a protection circuit module positioned on one side of the battery cell and electrically connected to the battery cell; a cover member covering at least a first cell side of the battery cell and at least a portion of a second cell side opposite to the first cell side and at least a portion of the protection circuit module; and a reinforcing member attached to the second cell side of the battery cell and overlapping the cover member at least in a portion of the second cell side of the battery cell, wherein the cover member may have a non-bonded region on one side facing the first cell side of the battery cell, and a bonded region exposed to the outside opposite to the one side.

Embodiments of the present disclosure provide a secondary battery pack including: a battery cell including an electrode assembly and a case accommodating the electrode assembly; a protection circuit module positioned on one side of the battery cell and electrically connected to the battery cell; a cover member covering at least a portion of a first cell side of the battery cell and at least a portion of a second cell side of the battery cell, the second cell side opposite to the first cell side; and a reinforcing member attached to the second side and overlapping the cover member on at least a portion of the second cell side, wherein the cover member has a non-bonded region on one side facing the first cell side and a bonded region exposed to an exterior opposite to the one side.

According to the present disclosure, by adding a reinforcing member made of a heat-shrinkable material to between the cover member that covers the outside of the battery cell and the battery cell, tension is applied to the cover member by the shrinkage of the reinforcing member, thereby reinforcing the adhesion and rigidity of the central part of the battery cell, thereby reducing the level of transient deformation due to an impact load when dropped.

However, the technical effects to be achieved in the embodiment of the disclosure are not limited to the technical problems mentioned above, and other technical effects not mentioned herein will be clearly understood from the following description by those skilled in the art to which the disclosure belongs.

### BRIEF DESCRIPTION OF DRAWINGS

The following drawings attached to this specification illustrate preferred embodiments of the present disclosure, and serve to further understand the technical idea of the present disclosure together with the detailed description of the present disclosure, and thus, the present disclosure should not be construed as being limited to the matters described in such drawings.

FIG. 1 is a perspective view showing the structure of a secondary battery according to embodiments of the present disclosure.

FIG. 2 is an exploded perspective view of a secondary battery pack including a battery cell according to embodiments of the present disclosure.

FIG. 3 is a plan view of a secondary battery pack according to embodiments of the present disclosure.

FIG. 4 is a schematic diagram showing an attachment process of a cover member and a reinforcing member according to embodiments of the present disclosure.

FIG. 5 is a schematic diagram showing an attachment process of a cover member and a reinforcing member according to embodiments of the present disclosure.

FIG. 6 is a schematic diagram showing an attachment process of a cover member and a reinforcing member according to embodiments of the present disclosure.

FIG. 7 is a cross-sectional view of a secondary battery pack including a cover member entirely covering a battery cell according to embodiments of the present disclosure.

FIG. 8 is a plan view of a reinforcing member according to embodiments of the present disclosure.

FIGS. 9 and 10 are plan views of reinforcing members according to embodiments of the present disclosure.

FIG. 11 is a view schematically showing a smartphone equipped with a secondary battery pack according to an embodiment of the present disclosure;

FIGS. 12A and 12B illustrate perspective views of an example of a battery pack; and

FIGS. 13A and 13B illustrate perspective and side views of examples of a vehicle body and a vehicle components.

### DETAILED DESCRIPTION OF EXEMPLARY EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way. Therefore, the embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application. In addition, it will be understood that the terms “comprise or include” and/or “comprising or including,” when used in this specification, specify the presence of stated features, integers, steps, operations, elements, and/or components but do not preclude the presence or addition of one or more other features, integers, steps, operations, elements, components, and/or groups thereof. In addition, when describing embodiments of the present disclosure, the wording “may~” or “may be~” may include “one or more embodiments of the present disclosure.”

In addition, for a better understanding of the invention, the attached drawings are not drawn to scale and the dimensions of some components may be exaggerated. In addition, the same reference numbers may be assigned to the same components in different embodiments.

A reference to two objects in comparison being the same means that they are substantially the same. Thus, the wording “substantially the same” may include cases where the same is considered to be a low level in the related art, for example, a deviation within 5%. In addition, when any of parameters is referred to as being uniform in a given region, it may mean that the parameter is uniform from an average perspective.

It will be understood that, although the terms “first,” “second,” etc., may be used herein to describe various components, these components should not be limited by these terms. These terms are used to distinguish one component from another component. Thus, unless otherwise defined, a first component described below could be termed a second component, without departing from the spirit and scope of the present disclosure.

Throughout the specification, the singular forms are intended to include the plural forms as well, unless the context clearly indicates otherwise.

The arrangement of an arbitrary component on the “upper portion (or lower portion)” or “upper (or lower)” of a component means that an arbitrary component is placed in contact with the upper (or lower) surface of the component. In addition, it may mean that other components may be interposed between the component and any component disposed on (or under) the component.

Also, it will be understood that when an element is referred to as being “coupled to,” “linked to,” or ““connected to” another element, these elements can be directly coupled or connected to each other, another intervening element may be present therebetween, or the respective elements may be coupled, linked, or connected to each other through another elements. In addition, it will be understood that when an element is referred to as being electrically coupled to another element, the element can be directly connected to another element or an intervening element may be present therebetween such that the element and another element are indirectly connected to each other.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

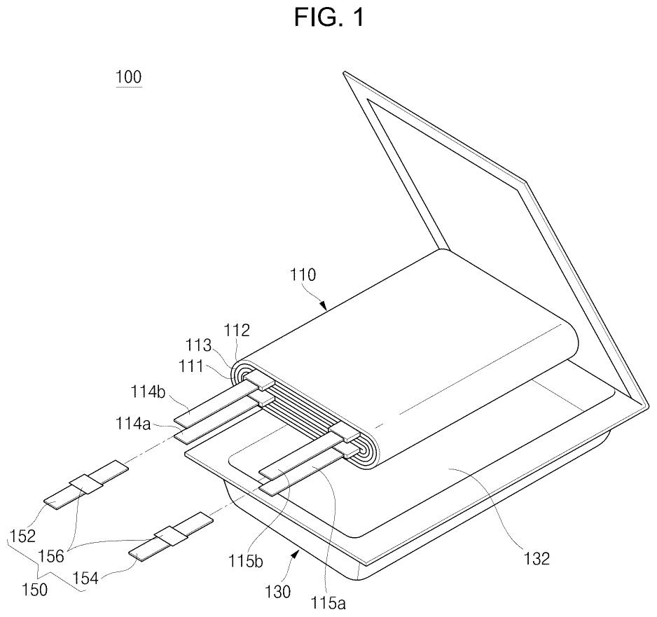

FIG. 1 is a perspective view showing the structure of a secondary battery.

As shown in FIG. 1, the secondary battery 100 includes an electrode assembly 110 and a pouch 130 that accommodates the electrode assembly 110.

The electrode assembly 100 includes a negative electrode plate 111 as a first electrode plate, a positive electrode plate 112 as a second electrode plate, and a separator 113 interposed therebetween. In some embodiments, an electrode assembly may be provided by stacking a negative electrode plate 111, a separator 113, and a positive electrode plate 112, each of which is provided in a thin plate shape or film shape. In some embodiments, the electrode assembly 110 may have one or more electrode assemblies 110 stacked so as to be adjacent to each other or one another to then be accommodated inside the case, and the number of electrode assemblies 110 is not limited in the present disclosure. In the electrode assembly 110, the first electrode plate 111 may serve as a negative electrode, and the second electrode plate 112 may serve as a positive electrode. The first electrode plate 111 may serve as a positive electrode, and the second electrode plate 112 may serve as a negative electrode.

The negative electrode plate 111 may be formed by applying a first electrode active material such as graphite or carbon on a first electrode current collector formed of a metal foil such as copper, a copper alloy, nickel, or a nickel alloy. The negative electrode plate 111 may include a first active material layer to which a first electrode active material is applied. The negative electrode plate 111 may include a first uncoated portion, which is a region to which the first electrode active material is not applied.

The negative electrode plate 111 may include a negative electrode tab 114a and 114b electrically connected to a negative electrode uncoated portion. In some embodiments, the negative electrode tab 114a and 114b may be fixed (e.g., welded) to a negative electrode non-coating portion in an approximately flat shape. For example, the negative electrode tab 114a and 114b may be fixed to the negative electrode non-coating portion by ultrasonic welding, laser welding, or resistance welding. That is, one end of the negative electrode tab 114a and 114b may be electrically connected to the negative electrode non-coating portion, and the other end may protrude and extend to the outside. In some embodiments, the negative electrode tab 114a and 114b may be formed by cutting the negative electrode plate 111 in advance so as to protrude to one side when manufacturing the negative electrode plate 111, and may protrude further to one side than the separator 113 without separately cutting.

A negative electrode active material, i.e., the first electrode active material, may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, or the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

The positive electrode plate 112 may be by applying a second electrode active material such as graphite or carbon on a second electrode current collector formed of a metal foil such as aluminum or an aluminum alloy. The positive electrode plate 112 may include a second active material layer to which a second electrode active material is applied. The positive electrode plate 112 may include a second uncoated portion, which is a region to which the second electrode active material is not applied.

The positive electrode plate 112 may include a positive electrode tab 115a and 115b electrically connected to a positive electrode uncoated portion. In some embodiments, the positive electrode tab 115a and 115b may be fixed (e.g., welded) to a positive electrode non-coating portion in an approximately flat shape. For example, the positive electrode tab 115a and 115b may be fixed to the positive electrode non-coating portion by ultrasonic welding, laser welding, or resistance welding. That is, one end of the positive electrode tab 115a and 115b may be electrically connected to the positive electrode non-coating portion, and the other end may protrude and extend to the outside. In some embodiments, the positive electrode tab 115a and 115b may be formed by cutting the positive electrode plate 112 in advance so as to protrude to one side when manufacturing the positive electrode plate 112, and may protrude further to one side than the separator 113 without separately cutting.

As a positive electrode active material, the second electrode material, a compound capable of reversibly intercalating/deintercalating lithium (e.g., a lithiated intercalation compound) may be used. For example, at least one of a composite oxide of lithium and a metal including cobalt, manganese, nickel, or combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

As the current collector, aluminum (Al) may be used, but is not limited thereto.

In some embodiments, an electrode lead 150 electrically connects the negative electrode tabs 114a and 114b, and the positive electrode tab 115a and 115b to the exterior. The negative electrode tab 114a and 114b, and the positive electrode tab 115a and 115b are respectively welded to a negative electrode lead 152 and a positive electrode lead 154 of an external terminal to be electrically connected to the exterior environment. A tab film 156 for insulation from the pouch 130 is attached to the negative electrode lead 152 and the positive electrode lead 154. A pouch 130 may also be referred to as a case.

The separator 113 may be interposed between the negative electrode plate 111 and the positive electrode plate 112 to prevent electrical short-circuit between the negative electrode plate 111 and the positive electrode plate 112. In some embodiments, the separator 113 are provided in a pair, and the negative electrode plate 111 may be sandwiched between the pair of separators 113.

Depending on the type of lithium secondary battery, the separator may be present between a positive electrode and a negative electrode. As the separator, polyethylene, polypropylene, polyvinylidene fluoride, or a multilayer film of two or more layers thereof may be used.

The separator 113 may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or combinations thereof but is not limited thereto.

The organic material and the inorganic material may be mixed in one coating layer or may be in the form of a coating layer containing an organic material and a coating layer containing an inorganic material that are laminated on each other.

In a state in which the electrode assembly 110 is accommodated in the pouch 130, sealing parts 132 of edges of the pouch 130 come into contact with each other (e.g., the sealing parts 132 around the periphery of the bottom portion of the pouch 130 come into contact with a corresponding peripheral area of the top potion (e.g., a cover) of the pouch 130) to be sealed. The sealing is performed in a state in which the tab film 156 is disposed between the sealing parts 132. As shown in FIG. 1, the form in which the tab film 156 is attached to each of the negative electrode tab 114a and 114b, and the positive electrode tab 115a and 115b is defined as a “separable tab film” (e.g., this sealing structure is referred to as a separable sealing structure).

The sealing parts 132 at the bottom portion of the pouch 130 as well as the top portion (e.g., the entire cover or at least the peripheral area of the cover) may be made of a heat-fusible material and may have a structure in which sealing is achieved by bonding heat-fusible layers to each other. Because the heat-fusible material generally has relatively weak adhesion to metal, the tab film 156 in the form of a thin film is attached to a tab to be fused to the pouch 130. However, in the separable sealing structure, the tab film 156 is attached to the negative electrode lead 152 and the positive electrode lead 154 and then welded thereto, followed by being heat-fused with the pouch 130, and thus, workability and productivity may be improved. The pouch 130 may have an internal space and may accommodate the electrode assembly 110 in the internal space.

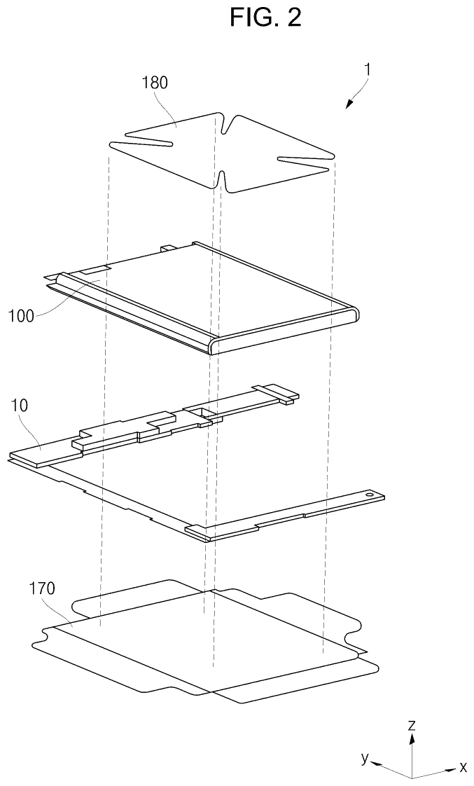

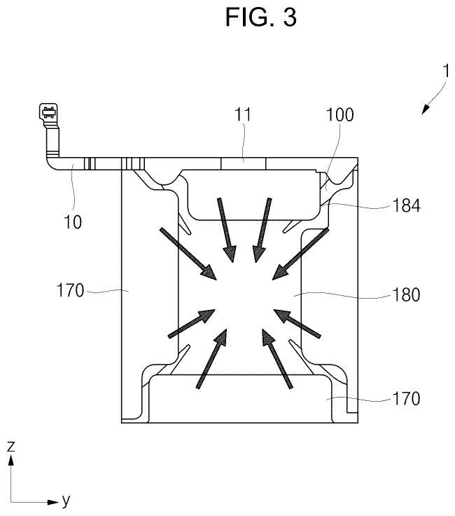

FIG. 2 is an exploded perspective view of a secondary battery pack including a battery cell. FIG. 3 is a plan view of a secondary battery pack.

Referring to FIGS. 2 and 3, a secondary battery pack 1 may include a battery cell 100, a cover member 170, a reinforcing member 180, and a protection circuit module 10.

In some embodiments, the secondary battery pack 1 may be inserted and fixed into an electronic device structure. For example, a pouch-type secondary battery that supplies power to a smartphone 1000 may be installed inside the frame of the smartphone.

As a method for fixing a secondary battery to a smartphone, conventional bonding methods were utilized to bond a battery surface that comes into contact with the smartphone. However, such conventional methods are disadvantageous in that it is difficult for general consumers to directly replace the battery due to a strong adhesive force. “Dismantling force” is becoming a test standard showing the force required for general consumers to dismantle the secondary battery from the smartphone. Based on this standard, a wrapping-type secondary battery-smartphone fixing method can be utilized to solve this disadvantage.

The wrapping-type secondary battery-smartphone fixing method relates to the upper corner of the secondary battery being fixed with an adhesive tape, no adhesive force is applied to the lower part of the battery that comes into contact with the smartphone. Accordingly, the dismantling force is relatively low, making it relatively easy to directly replace the battery. However, because there is no fixing force at the contact surface between the secondary battery and the smartphone, the central part of the secondary battery, which is not fixed, may become transiently deformed, which may pose a safety risk in a situation where a smartphone is dropped and/or subjected to an impact load.

In some embodiments, in the secondary battery pack 1, the protection circuit module 10 is connected to the battery cell 100, and the cover member 170 and the reinforcing member 180 may be attached to at least a portion of the outer surface, such that the secondary battery pack 1 can be inserted into the electronic device. Referring to FIG. 2, the battery cell 100, the cover member 170, the protection circuit module 10, and the reinforcing member 180 may interact with one another and can reinforce the structural strength of the battery cell 100. In some embodiments, the reinforcing member 180 is positioned on the upper portion of the battery cell 100 and overlaps the cover member 170, and can serve to reinforce the central part of the battery cell 100. In this manner, additional rigidity can be provided to the central part of the secondary battery.

In some embodiments, the protection circuit module 10 protects the battery cell 100 from overcharge, overdischarge, overheating, etc. The protection circuit module 10 may be a battery management system (BMS). The protection circuit module 10 may mount electronic components and protection circuits, etc., and may be electrically connected to the battery cell 100.

In some embodiments, the protection circuit module 10 may be positioned on the upper side of the battery cell 100 and may be protected and fixed by a protection tape 11. The protection tape 11 includes an insulating function and has heat resistance and chemical resistance, and thus can safely protect a protection circuit from corrosion due to heat or chemicals of the battery. For example, the protection tape 11 may include polyimide (PI) or polyester (PET).

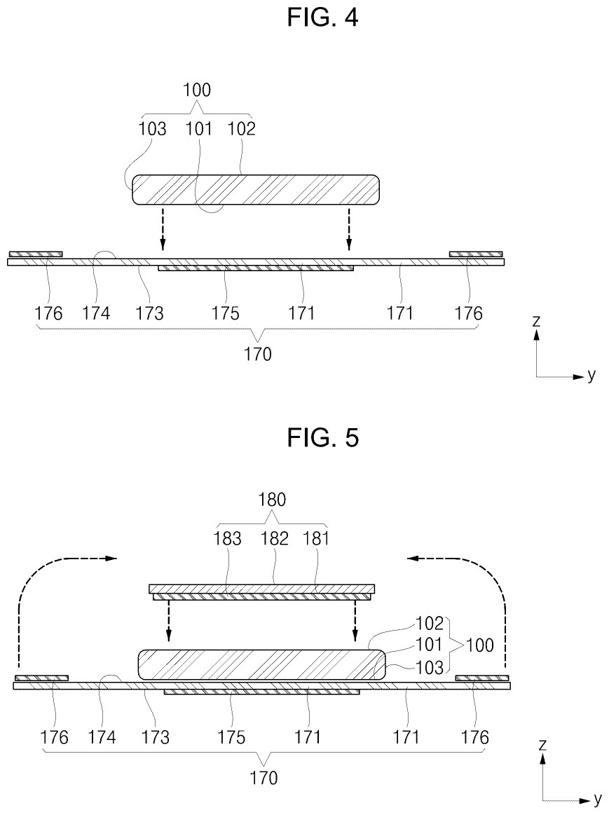

FIGS. 4 to 6 are schematic diagrams showing an attachment process of a cover member and a reinforcing member.

Referring to FIG. 4, the battery cell 100 may include a first cell side 101 which is a bottom surface, a second cell side 102 which is a surface opposite from the first cell side 101, and a lateral cell side 103 which connects the first cell side 101 and the second cell side 102.

In some embodiments, the cover member 170 may include a main portion 171 positioned in the central region with respect to the x-axis direction and having an area corresponding to the first cell side 101 of the battery cell 100. In some embodiments, the cover member 170 may include a wing portion 172 extending in both directions from the main portion 171.

In some embodiments, the cover member 170 may include a first cover side 173 which is a bottom surface and a second cover side 174 which is a surface opposite to the first cover side 173. The cover member 170 may include a first adhesive layer 175 which is attached to the bottom surface of the main portion 171 of the first cover side 173. In some embodiments, the cover member 170 may include a second adhesive layer 176 which is attached to a plane of the wing portion 172 of the second cover side 174. The second adhesive layer 176 may include at least two adhesive layers, and the two adhesive layers may be attached to each end of the wing portion 172.

In some embodiments, the first adhesive layer 175 may be disposed on the first cover side 173 of the cover member 170 corresponding to the position where the battery cell 100 is placed. The first adhesive layer 175 may have a width less than that of the battery cell 100.

In some embodiments, the width of the second adhesive layer 176 may correspond to the width of the edge region 1722 covering the second cell side 102 of the battery cell 100. In some embodiments, the width of the second adhesive layer 176 may correspond to the width of the cover member 170 attached to the second cell side 102 of the battery cell 100. For example, the second adhesive layer 176 may have a width less than that of the cover member 170 attached to the second cell side 102 of the battery cell 100.

In some embodiments, the cover member 170 may include polyethylene terephthalate (PET), polyimide (PI), polypropylene (PP), polyethylene (PE), polyvinyl chloride (PVC), polycarbonate (PC), polytetrafluoroethylene (PTFE), thermoplastic polyurethane (TPU), polyvinylidene fluoride (PVDF), polystyrene (PS), or the like.

Referring to FIG. 5, the reinforcing member 180 may be attached to the second cell side 102 of the battery cell 100 before the cover member 170 covers the battery cell 100. The battery cell 100 may be positioned on the main portion 171 of the cover member 170 with the first cell side 101 facing the second cover side 174 of the cover member 170.

In some embodiments, the reinforcing member 180 may include a first reinforcing side 181 facing the second cell side 102 of the battery cell 100, and a second reinforcing side 182 that is an upper plane opposite to the first reinforcing side 181. The reinforcing member 180 may include a reinforcing member adhesion layer 183 attached to the first reinforcing side 181. For example, the width of the reinforcing member adhesion layer 183 may be equal to or less than the width of the reinforcing member 180.

In some embodiments, the reinforcing member 180 may include a heat-shrinkable material. For example, the reinforcing member 180 may include polyolefin, polyethylene (PE), polyvinyl chloride (PVC), polytetrafluoroethylene (PTFE), polyvinylidene fluoride (PVDF), silicone rubber, vinylidene fluoride, elastomer, etc. The reinforcing member 180 includes a heat-shrinkable material to suppress deformation that may occur when the battery cell 100 is subjected to external impact, and to reinforce the strength of the battery cell 100.

In some embodiments, the first adhesive layer 175, the second adhesive layer 176, and the reinforcing member adhesion layer 183 may include polyimide, polyethylene terephthalate (PET), acrylic adhesive, silicone adhesive, epoxy adhesive, polyurethane, polyvinylidene fluoride (PVDF), polyethylene foam, polypropylene (PP), polyvinyl chloride (PVC), rubber-based adhesive, thermoplastic elastomer (TPE), thermoset resins, or the like. In some embodiments, the first adhesive layer 175, the second adhesive layer 176, and the reinforcing member adhesion layer (183) may include substantially the same material, but may include different materials.

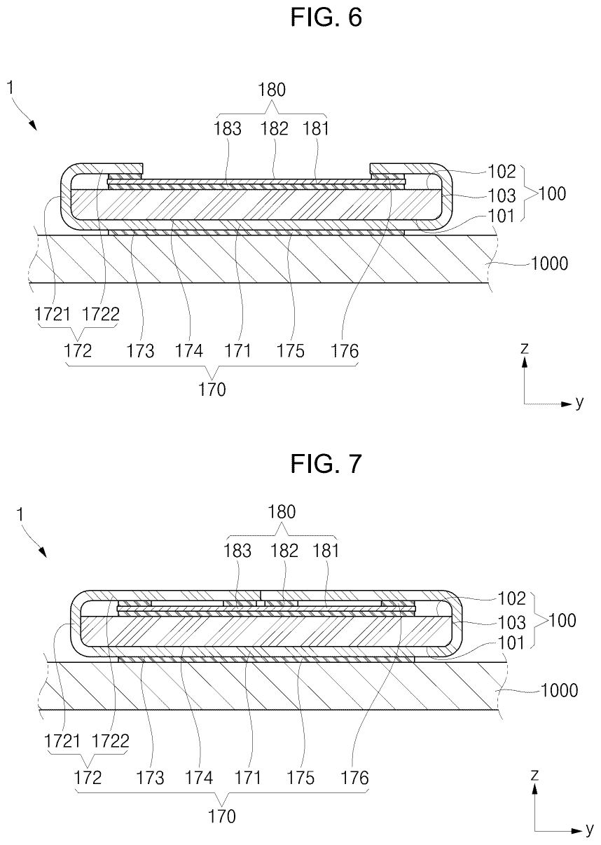

Referring to FIG. 6, the cover member 170 may cover the first cell side 101 and the lateral cell side 103 of the battery cell 100, and at least a portion of the second cell side 102. The cover member 170 is constructed to cover the first cell side 101 of the battery cell 100 and the second cell side 102 positioned opposite thereto, and, by including an adhesive layer, may attach the battery cell 100 to the electronic device a structure. The cover member 170 may protect the battery cell 100 from the external environment and may provide mechanical rigidity. The cover member 170 may fix the battery cell 100 together with the protection circuit module 10 positioned on one side of the battery cell 100, and can protect the battery cell 100 from external impact.

In some embodiments, the wing portion 172 of the cover member 170 may include a connection region 1721 that extends from an end of the main portion 171 to both sides and is bent to cover the lateral cell side 103 of the battery cell 100. In some embodiments, the wing portion 172 of the cover member 170 may include an edge region 1722 that extends from the connection region 1721 and is bent to cover at least a portion of the second cell side 102 of the battery cell 100.

In some embodiments, the cover member 170 may include a non-bonded region positioned on the second cover side 174 of the main portion 171. An adhesive layer may not be interposed between the first side 101 of the battery cell 100 and the second cover side 174 of the main portion 171. In some embodiments, the cover member 170 may include a non-bonded region positioned on the second cover side 174 of the connection region 1721. An adhesive layer may not be interposed between the lateral cell side 103 of the battery cell 100 and the second cover side 174 of the connection region 1721.

In some embodiments, the reinforcing member 180 may be interposed between the edge region 1722 of the cover member 170 and the second cell side 102 of the battery cell 100. The second reinforcing side 182 of the reinforcing member 180 may face the second cover side 174 of the edge region 1722. The reinforcing member 180 may be attached to the second cell side 102 of the battery cell 100 through the reinforcing member adhesion layer 183 and may overlap the cover member 170 on at least a portion of the second cell side 102 of the battery cell 100 through the second adhesive layer 176. In some embodiments, at least a portion of the second reinforcing side 182 of the reinforcing member 180 may be attached to the second cover side 174 of the edge region 1722.

In some embodiments, the cover member 170 may be attached (fixed) to an electronic device, such as the smartphone 1000, through the first adhesive layer 175 of the first cover side 173, which is positioned on the first cover side 173 of the main portion 171.

FIG. 7 is a cross-sectional view of a secondary battery pack including a cover member entirely covering a battery cell.

Referring to FIG. 7, the edge region 1722 of the cover member 170 may cover the entire second cell side 102 of the battery cell 100. In some embodiments, the reinforcing member 180 interposed between the cover member 170 and the battery cell 100 may not be exposed to the exterior environment due to the edge region 1722 of the cover member 170. In some embodiments, the second cover side 174 of the edge region 1722 may be attached to at least a portion of the second reinforcing side 182 of the reinforcing member 180. For example, the second adhesive layer 176 may be disposed at positions corresponding to the ends of the edge region 1722 and positions corresponding to the ends of the reinforcing member 180. In some embodiments, the second adhesive layer 176 may extend from the ends of the edge region 1722 to the positions corresponding to the positions of the ends of the reinforcing member 180.

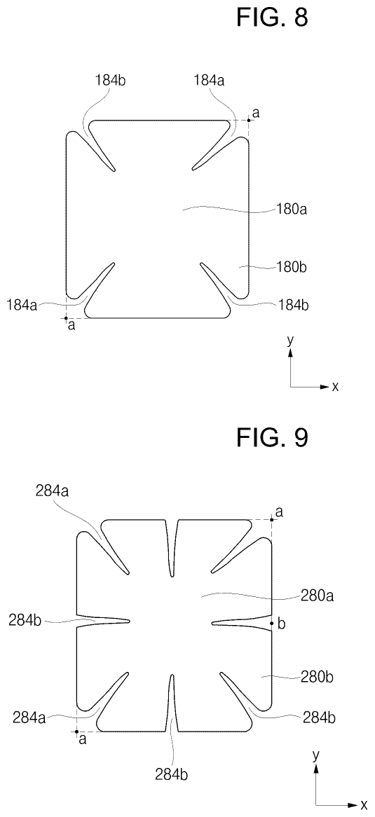

FIG. 8 is a plan view of a reinforcing member.

Referring to FIG. 8, the reinforcing member 180 may include, on a plane, a central region 180a and an extension region 180b extending from the central region 180a. The reinforcing member 180 may include at least two cut-out portions 184 provided in the extension region 180a.

In some embodiments, the at least two cut-out portions 184 may form a pair. For example, the two cut-out portions 184 may include a pair of first cut-out portions 184a at one edge and at the other edge diagonally disposed from the one edge, respectively. In some embodiments, the at least two cut-out portions 184 may include a pair of second cut-out portions 184b symmetrically to the pair of first cut-out portions 184a with respect to the y-axis.

In some embodiments, the cut-out portions 184 of the reinforcing member 180 may correspond to the respective corner positions of the battery cell 100. The number of cut-out portions 184 may correspond to the number of wing portions 172 of the cover member 170. For example, when the number of wings of the wing portion 172 is four, the number of cut-out portions 184 may be four, and the cut-out portions 184 may be positioned at the respective corner positions of the battery cell 100. Accordingly, the reinforcing member 180 can efficiently transmit forces in four directions.

In some embodiments, the reinforcing member 180 may be designed to concentrate tension toward the center thereof. When the reinforcing member 180 is subject to shrinkage, the respective corners and edges thereof may relatively shrink first, creating a shape in which tension is concentrated toward the center.

In some embodiments, the reinforcing member 180 may form cut-out portions 184 at the corners, thereby distributing tension. When the reinforcing member 180 shrinks by the cut-out portions 184, a location having concentrated tension is created, and the existence of the concentrated tension can be effective in gathering the tension toward the center. If the cut-out portions 184 are absent, the entire reinforcing member 180 may shrink evenly, distributing the tension such that sufficient force will not be transmitted to a desired part.

In some embodiments, the cut-out portions 184 may be cut toward the center of the reinforcing member 180. For example, the length of the cut portion of each of the cut-out portions 184 (the length from the position a to the cutting end) may be about 20% to about 40% of the maximum length from one side to the other side of the reinforcing member 180 (the length from a to a).

When the length of the cut portion of each of the cut-out portions 184 exceeds about 40% of the maximum length, the durability of the reinforcing member 180 may be reduced. For example, the deeper the cut portion, the weaker the overall strength of the reinforcing member 180 may be. When the tension is excessively concentrated during or after the shrinkage, there may be a risk that the reinforcing member 180 may be torn or damaged. In addition, the deep cut portion weakens the connection between the respective cut-out portions 184 of the reinforcing member 180, so that there may be a risk that this connection may be broken when shrinking. If the cut portion is too deep, the area of each cut-out portion 184 is reduced, so that the tension may not be distributed evenly. If the cut portion is too deep, the reinforcing member 180 is more likely to shrink asymmetrically, so that the reinforcing member 180 may not shrink evenly toward the center, deforming into a biased or distorted configuration to one side.

In some embodiments, the planar area of the reinforcing member 180 may be about 80% to about 90% of the area of the second cell side 102 of the battery cell 100. In some embodiments, when the planar area of the reinforcing member 180 is less than about 80% of the second cell side 102, the magnitude of the tension applied when the reinforcing member 180 shrinks may be limited, and the force concentrated toward the center may be reduced, making it difficult to stably fix the battery cell 100.

In some embodiments, the reinforcing member 180 is shown as having a straight edge, but it can be implemented as a curve. For example, the overall geometry of reinforcing member 180 may be circular (or elliptical) rather than being square.

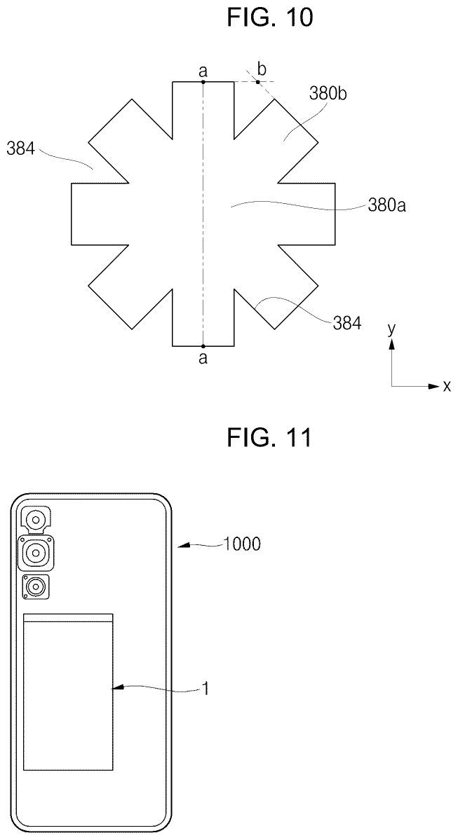

FIGS. 9 and 10 are plan views of reinforcing members.

Referring to FIG. 9, a reinforcing member 280 may include a central region 280a on a planar surface and extension regions 280b extending from the central region 280a. The reinforcing member 280 may include eight cut-out portions 284 provided in the extension regions 280b. In some embodiments, the cut-out portions 284 may include first cut-out portions 284a provided on a corner side of the reinforcing member 280 and second cut-out portions 284b provided on the vertical axis and the horizontal axis.

In some embodiments, the first cut-out portions 284a may be provided corresponding to the corner positions of the battery cell 100, and the second cut-out portions 284b may be provided corresponding to the positions to which the wing portions 172 of the cover member 170 are attached.

In some embodiments, the cut-out portions 284 may be cut toward the center of the reinforcing member 280. For example, the length of the cut of each of the cut-out portions 284 (the length from a or b to the cutting end) may be about 20% to about 40% of the maximum length from one side to the other side of the reinforcing member 280 (the length from a to a).

The reinforcing member 280 as shown in FIG. 9 includes cut-out portions 284 with more cuts than the cut-out portions 184, so that tension is distributed and applied at multiple points of the reinforcing member 280. Accordingly, when shrinking, the force is more evenly concentrated toward the center. This can further increase the effect of concentrating tension at the center. Having an increased number of cuts may widen the overall shrinkage area, which can be advantageous in generating tension that is more strongly concentrated toward the center in response to heat. When there is an increased number of cuts, various parts of the reinforcing member 280 can shrink independently, which can enable more flexible deformation when conforming to various types of surfaces.

Referring to FIG. 10, a reinforcing member 380 may include a planar central region 380a and extension regions 380b extending from the central region 380a. The reinforcing member 380 may include eight cut-out portions 384 provided in the extension regions 380b. In some embodiments, a plurality of cut-out portions 384 may be provided at constant intervals along the periphery of the reinforcing member 380. For example, the reinforcing member 380 may be provided in a serrated shape in which the extension regions 380b extend at constant intervals by being spaced apart by the cut-out portions 384.

In some embodiments, the cut-out portions 384 may be cut toward the center of the reinforcing member 380. For example, the length of the cut portion of each of the cut-out portions 384 (the length from b to the cutting end) may be 20% to 40% of the maximum length from one side to the other side of the reinforcing member 380 (the length from a to a).

The reinforcing member 280 as shown in FIG. 10 has cut-out portions 384 wide and angled. Accordingly, the reinforcing member 380 may shrink evenly in a certain direction when heat is applied. Wide cut portions can help distribute the force evenly toward the center. The angled cut-out portions 384 can concentrate the tension more definitely during shrinkage. The tension acts more definitely in straight sections, which may cause strong shrinkage toward the center. In some embodiments, the overall portion of the reinforcing member 380 and the cut-out portions 384 are shown as angled, but may be formed as gentle curves. If implemented as gentle curves, greater flexibility can be achieved.

FIG. 11 is a view schematically showing a smartphone 1000 equipped with a secondary battery pack 1. As shown in FIG. 11, a secondary battery pack 1 may be a small sized battery mounted in a small sized portable device such as a smartphone 1000. Because the secondary battery pack 1 has increased capacity while having a relatively slim internal structure, the secondary battery pack 1 may is used for small portable devices. As used herein, the terms “secondary battery” and “battery” have the same meaning and are different only in expression for convenience of description.

The secondary battery pack 1 may be a single cell, and can be used to manufacture a battery pack including a plurality of cells or to manufacture a larger battery pack including battery cells having increased size.

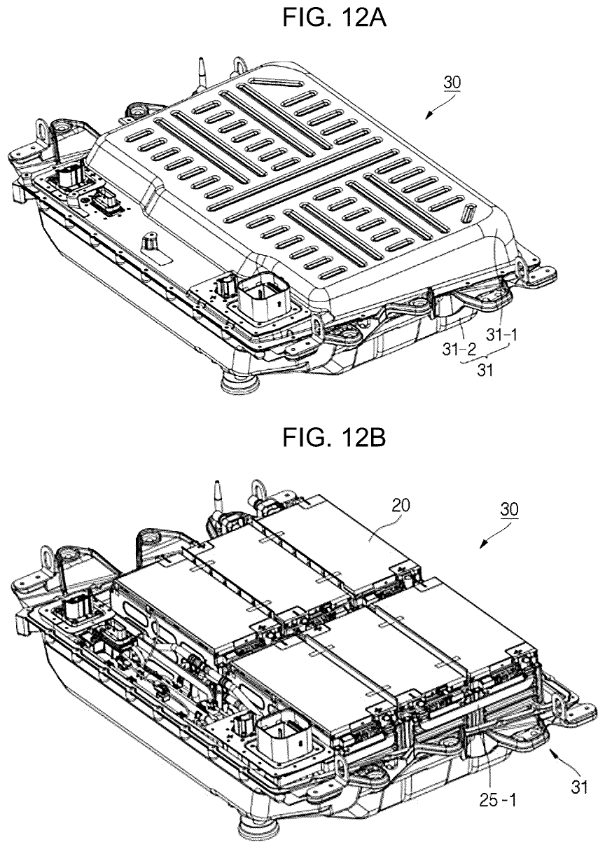

FIGS. 12A and 12B are perspective views showing an exemplary battery pack 30. The battery pack 30 may include a plurality of battery modules 20b and a housing 31 for accommodating the plurality of battery modules 20b. For example, the housing 31 may include first and second housings 31-1 and 31-2 coupled in opposite directions through the plurality of battery modules 20b. The plurality of battery modules 20b may be electrically connected to each other by using a bus bar 25-1, and the plurality of battery modules 20b may be electrically connected to each other in a series/parallel or series-parallel mixed method, thereby obtaining required electrical output.

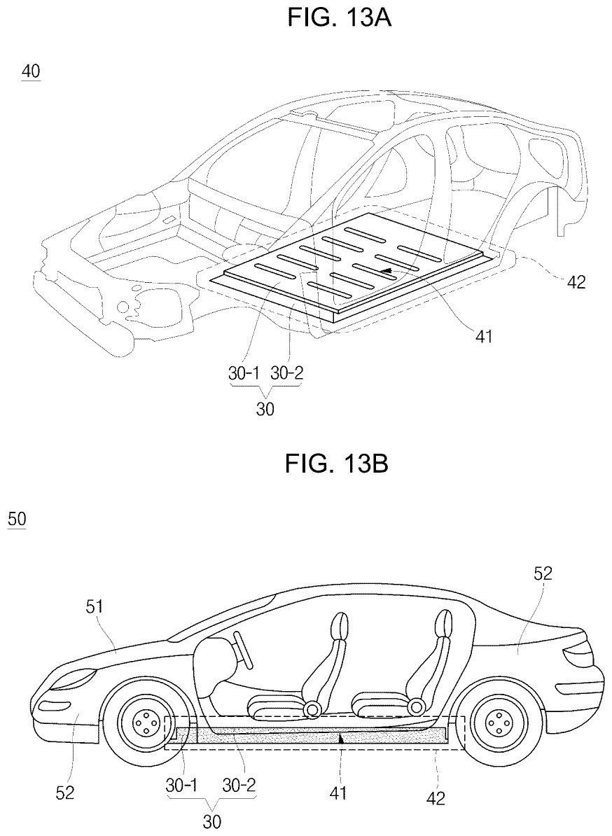

FIGS. 13A and 13B illustrate perspective and side views of examples of a vehicle body 40 and a vehicle components.

In FIG. 13A, a battery pack 30 may include a battery pack cover 30-1, which is a part of a vehicle underbody 41, and a pack frame 30-2 located under the vehicle underbody 41. In some embodiments, the battery pack cover 30-1 may correspond to the first housing 31-1, and the pack frame 30-2 may correspond to the second housing 31-2. The pack frame 30-2 and the battery pack cover 30-1 may be integrally formed with a vehicle floor 42. The vehicle underbody 41 separates the inside and outside of a vehicle, and the pack frame 30-2 may be located outside the vehicle.

Referring to FIG. 13B, a vehicle 50 may be formed by combining additional parts, such as a hood 51 in front of the vehicle and fenders 52 respectively located in the front and rear of the vehicle to a vehicle body 40. The vehicle 50 may include the battery pack 30 that include the battery pack cover 30-1 and the pack frame 30-2, and the battery pack 30 may be coupled to the vehicle body 40.

Although a few embodiments of the present disclosure have been shown and described, it would be appreciated by those skilled in the art that various changes and modifications may be made in this embodiment without departing from the principles and spirit of the disclosure, the scope of which is defined in the appended claims and their equivalents.

What is claimed is:

1. A secondary battery comprising:
a battery cell comprising an electrode assembly and a case accommodating the electrode assembly;
a cover member covering at least a portion of a first cell side of the battery cell and at least a portion of a second cell side of the battery cell, the second cell side opposite to the first cell side; and
a reinforcing member attached to the second cell side and overlapping the cover member on at least a portion of the second cell side.

2. The secondary battery as claimed in claim 1, wherein the cover member comprises:
a main portion having an area corresponding to the first cell side; and
a wing portion extending from the main portion and covering a lateral cell side and at least a portion of the second cell side.

3. The secondary battery as claimed in claim 2, wherein the wing portion comprises:
a connection region extending from an end of the main portion and bent to cover the lateral cell side; and
an edge region extending from the connection region and bent to cover at least a portion of the second cell side.

4. The secondary battery as claimed in claim 3, wherein the cover member further comprises a first cover side exposed to an exterior, a second cover side facing the battery cell, and a first adhesive layer attached to a region of the first cover side corresponding to the main portion.

5. The secondary battery as claimed in claim 4, wherein the cover member further comprises a non-bonded region positioned on a region of the second cover side corresponding to the main portion.

6. The secondary battery as claimed in claim 4, wherein the cover member further comprises a non-bonded region positioned on a region of the second cover side corresponding to the connection region.

7. The secondary battery as claimed in claim 4, wherein the cover member further comprises a second adhesive layer attached to a region of the second cover side corresponding to the edge region.

8. The secondary battery as claimed in claim 4, wherein the reinforcing member is interposed between the edge region and the second cell side.

9. The secondary battery as claimed in claim 7, wherein the reinforcing member comprises:
a first reinforcing side facing the second cell side; and
a second reinforcing side facing the second cover side corresponding to the edge region.

10. The secondary battery as claimed in claim 9, wherein the reinforcing member further comprises a reinforcing member adhesion layer attached to the first reinforcing side.

11. The secondary battery as claimed in claim 9, wherein the first reinforcing side is attached to the second cell side, and at least a portion of the second reinforcing side is attached to the second cover side corresponding to the edge region by the second adhesive layer.

12. The secondary battery as claimed in claim 1, wherein the reinforcing member comprises a heat-shrinkable material.

13. The secondary battery as claimed in claim 2, wherein the reinforcing member comprises at least two cut-out portions at the edge region.

14. The secondary battery as claimed in claim 13, wherein the at least two cut-out portions are located at corner positions of the battery cell, and wherein a number of the at least two cut-out portions is equal to a number of the wing portions.

15. The secondary battery as claimed in claim 13, wherein the at least two cut-out portions are cut toward a center of the reinforcing member, and a length of each of the cut-out portions are about 20% to about 40% of a maximum length extending from one side to an opposite side of the reinforcing member.

16. The secondary battery as claimed in claim 1, wherein a planar area of the reinforcing member is about 80% to about 90% of the area of the second cell side of the battery cell.

17. The secondary battery as claimed in claim 4, wherein the edge region of entirely covers the second cell side, and wherein the second cover side corresponding to the edge region is attached to at least a portion of the reinforcing member.

18. The secondary battery as claimed in claim 1, wherein the reinforcing member comprises a central region and a plurality of extension regions extending from the central region.

19. The secondary battery as claimed in claim 1, wherein at the end of the edge region, tension is applied to a central part of the battery cell.

20. A secondary battery pack comprising:
a battery cell comprising an electrode assembly and a case accommodating the electrode assembly;
a protection circuit module positioned on one side of the battery cell and electrically connected to the battery cell;
a cover member covering at least a portion of a first cell side of the battery cell and at least a portion of a second cell side of the battery cell, the second cell side opposite to the first cell side; and
a reinforcing member attached to the second cell side and overlapping the cover member on at least a portion of the second cell side,
wherein the cover member has a non-bonded region on one side facing the first cell side and a bonded region exposed to an exterior opposite to the one side.
